(19) United States
(12) Patent Application Publication
(10) Pub. No.: US 2015/0098318 A1
(43) Pub. Date: Apr. 9, 2015

(54) REDUNDANT NON-LOOPING PATHS

(71) Applicants: Mark Gooch, Roseville, CA (US); Shaun Wakumoto, Roseville, CA (US)

(72) Inventors: Mark Gooch, Roseville, CA (US); Shaun Wakumoto, Roseville, CA (US)

(21) Appl. No.: 14/372,514

(22) PCT Filed: Jan. 30, 2012
(86) PCT No.: PCT/US2012/023193

§ 371 Date: Jul. 16, 2014

(51) Int. Cl. H04L 12/24; H04L 12/707

(52) U.S. Cl. CPC H04L 41/0654; H04L 45/22
USPC 370/228

(57) ABSTRACT

An example method includes creating a plurality of redundant, non-looping paths to a plurality of switches, and providing information to the plurality of switches about the plurality of redundant, non-looping paths. The method further comprises assigning each of a plurality of clients to one of the plurality of redundant, non-looping paths, and providing information to the plurality of switches about which of the plurality of redundant, non-looping paths each client of the plurality of clients is assigned to. Then, in response to receiving a packet from a client of the plurality of clients, the method comprises transmitting the packet on one of the plurality of redundant, non-looping paths to one of the plurality of switches based at least in part on which of the plurality of redundant, non-looping paths the client is assigned to.

### BACKGROUND

In the networking technology space, there are various types of packets transmitted between source and destination devices. The most common type of packet is a unicast packet, which is a packet addressed to a single device. Other types of packets include broadcast, multicast, and unknown destination address packets. A broadcast packet is packet addressed to ail devices in a network. A multicast packet is a packet addressed to a group of destination devices in the network. And an unknown destination address packet, as the name suggests, is a packet for which a device (e.g., a switch) does not currently know the destination address. As described in greater detail below, broadcast, multicast, and unknown destination address packets are often handled differently than typical unicast packets, as demonstrated for example by current switch meshing approaches.

### BRIEF DESCRIPTION OF THE DRAWINGS

Example embodiments are described in the following detailed description and in reference to the drawings, in which:

FIG. 1 depicts a system in accordance with an embodiment;

FIG. 2 depicts a process flow diagram in accordance with a further embodiment;

FIG. 3 depicts a system in accordance with another embodiment;

FIG. 4 depicts a process flow diagram in accordance with still another embodiment; and

FIG. 5 depicts a block diagram of a mesh switch in accordance with an embodiment.

### DETAILED DESCRIPTION

Switch meshing is a switching technology that links together multiple switches to form a meshed switch domain. The meshed switch domain provides multiple switch paths between source and destination devices, and therefore allows different switch paths to be utilized for different packets. For example, an originating device (e.g., a workstation) can utilize a first path traversing switches 1, 2, and 5 in a meshed switch domain to transmit a unicast packet to a destination device (e.g., a server), and subsequently utilize a second path traversing switches 1, 3, 4, and 5 in the meshed switch domain to transmit another unicast packet to the same destination device. The decision to utilize the first path or the second path may be based on various conditions, such as the status of the switches, the status of the paths, and/or the contents of the packet being sent.

With specific respect to broadcast, multicast, and unknown destination address packets in a meshed switch domain, current switch meshing approaches utilize a single path through the meshed switch domain to propagate all broadcast, multicast, and unknown destination address packets to all switches. The single path originates at one switch and traverses every other switch in the meshed switch domain. This effectively enables the switch to distribute incoming broadcast, multicast, and/or unknown destination address packets to every other switch in the meshed switch domain via a single path. A potential problem with the approach, however, is that a segment in the single path may fail, and, as a result, the switch may not be able to transmit the broadcast, multicast, and/or unknown destination address packets until the path is rebuilt. This may create propagation delays and congestion, which may be unacceptable in certain environments. A further potential problem is that a switch may become inundated with a large number of broadcast, multicast, and/or unknown destination address packets in a short period of time. As a result, a bottleneck may form because all of the packets must be output via a single path. This bottleneck may create transmission delays which, as mentioned above, may not be acceptable in certain environments.

Various embodiments described herein address at least the above by providing a novel and previously unforeseen approach to distributing broadcast, multicast, and unknown destination address packets in a mesh switching environment. More precisely, various embodiments assign clients to different redundant, non-looping paths in the meshed switch domain to distribute broadcast, multicast, and/or unknown destination address packets in a balanced and reliable manner. In addition, various embodiments utilize algorithms to distribute broadcast, multicast, and/or unknown destination address packets in a reliable and balanced manner among the various redundant, non-looping paths in the meshed switch domain.

In one example embodiment, a method is provided. The method comprises creating a plurality of redundant, non-looping paths to a plurality of switches, and providing information to the plurality of switches about the plurality of redundant, non-looping paths. The method further comprises assigning each of a plurality of clients to one of the plurality of redundant, non-looping paths, and providing information to the plurality of switches about which of the plurality of redundant, non-looping paths each client of the plurality of clients is assigned to. Then, in response to receiving a packet from a client of the plurality of clients, the method comprises transmitting the packet on one of the plurality of redundant, non-looping paths to one of the plurality of switches based at least in part on which of the plurality of redundant, non-looping paths the client is assigned to.

In a further embodiment, another method is provided. The method comprises storing an algorithm to apply to incoming packets, creating a plurality of redundant, non-looping paths to a plurality of switches, providing information to the plurality of switches about the plurality of redundant, non-looping paths, and providing information to the plurality of switches about a plurality of attached clients. Moreover, the method comprises receiving a packet from one of the plurality of attached clients, applying information associated with the packet to the algorithm to produce a forwarding result, selecting one of the plurality of redundant, non-looping paths based at least in part on the forwarding result, and transmitting the packet on the selected one of the plurality of redundant, non-looping paths.

In still another embodiment, a system is provided. The system comprises a first switch and a second switch. The first switch is configured to store an algorithm to apply to incoming packets, provide information to a second switch about a plurality of redundant, non-looping paths and attached clients, apply information associated with a received packet to the algorithm to produce a forwarding result, select one of the plurality of redundant, non-looping paths based at least in part on the forwarding result, and transmit the packet on the selected one of the plurality of redundant, non-looping paths. The second switch is configured to store the algorithm to apply to incoming packets, store the information about the plurality of redundant, non-looping paths and the attached clients, receive the packet originating at the first switch, and apply information associated with the received packet to the algorithm to produce a second forwarding result, where the second forwarding result may be the same as the first forwarding result.

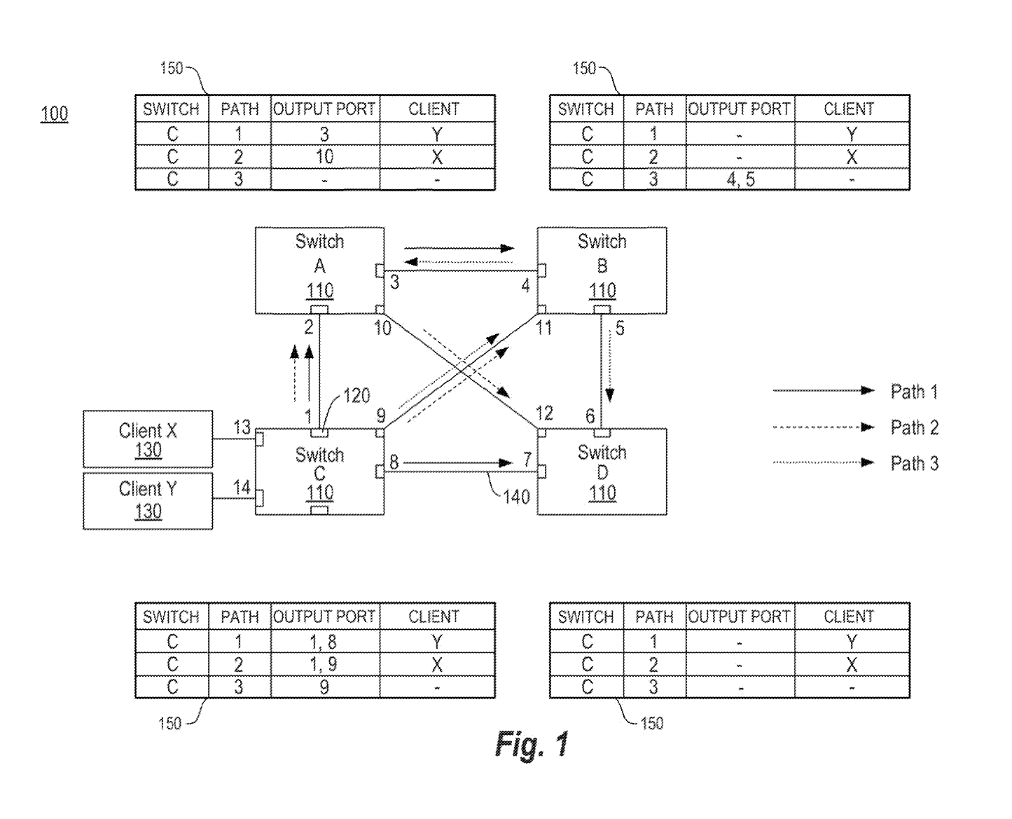

FIG. 1 depicts a system 100 in accordance with one embodiment. The system 100 comprises a plurality of switches 110 (each with a plurality of ports 120), a plurality of clients 130, and a plurality of segments 140. It should be readily apparent that the system 100 depicted in FIG. 1 represents a generalized illustration and that other elements may be added or existing elements may be removed, modified, or rearranged without departing from the scope of the present disclosure.

Each client 130 is generally a computing device configured to communicatively couple to a switch 110. For example, a client 130 may be a laptop, desktop, tablet, server, workstation, storage device, security appliance, wireless access point, wireless controller, smart phone, medical instrument, scientific instrument, Voice-over-IP (VoIP) phone, or the like. The client 130 may utilize wireless and/or wired mediums (e.g., radio frequency (RF), fiber-optic, coaxial, twisted pair, etc.) to communicate with the switch 110. In some implementations, a switch that is not part of the meshed switch domain may be an intermediate between the client and the switch 110. For example, the client 130 may communicate with a non-mesh switch which in turn communicates with a mesh switch 110.

Each switch 110 is generally a computer networking device that is configured to connect other devices via network segments 140, and to forward packets to and from the other devices via network segments 140 and associated ports 120. In addition, each switch 110 is configured to store forwarding tables 150, and to forward incoming packets based at least in part on information within the forwarding tables 150. For example, switch C in FIG. 1 may be a mesh switch configured to receive packets from client X and/or client Y and transmit the packets to mesh switches A, B, or D via the network segments 140 and the associated ports 120 based on the internal forwarding tables 150. Similarly, switch C may receive packets from switches A, B, or D and transmit the packets to clients X or Y via the network segments 140 and the associated ports 120 based on the internal forwarding tables 150.

In addition to the above, and in accordance with the embodiment depicted in FIG. 1, each mesh switch 110 may be configured to (i) build a plurality of redundant, non-looping paths to the other switches 110 in the meshed switch domain, (ii) distribute information about the built paths to the other switches 110 in the meshed switch domain, (iii) assign clients 130 to the built paths and inform the other switches 110 in the meshed switch domain of the assignments, and (iv) utilize the built paths to transmit incoming broadcast, multicast, and/or unknown destination address packets from the clients 130 to other switches 110 in the meshed switch domain. Each of these functions is described in greater detail below with reference to FIG. 1.

With regard to (i) building a plurality of redundant, non-looping paths to the other switches in the meshed switch domain, switch C in FIG. 1 may, for example, build three redundant, non-looping paths connecting switch C to each of switches A, B, and D (see paths 1, 2, and 3 in FIG. 1). The three paths may be redundant insofar as each path similarly connects switch C to each of switches A, B, and D, and may be non-looping insofar as each path does not traverse a switch or network segment more than once. As shown, path 1 may propagate received packets from port 1 on switch C to port 2 on switch A, as well as propagate packets from port 8 on switch C to port 7 on switch D. Switch A may then forward the received packets from port 3 on switch A to port 4 on switch B. Path 2, by contrast, may propagate packets from port 1 on switch C to port 2 on switch A, and from port 9 on switch C to port 11 on switch B. Switch A, in response to receiving the packets from switch C, may propagate the packets from port 10 on switch A to port 12 on switch D. Path 3, by further contrast, may propagate packets from port 9 on switch C to port 11 on switch B. Switch B may then forward the received packets from port 4 on switch B to port 3 on switch A, and from port 5 on switch B to port 6 on switch D.

After a switch builds a plurality of redundant, non-looping paths to the other switches in the meshed switch domain, the switch may (ii) distribute information about the paths to the other switches 110 in the meshed switch domain. For example, switch C may provide switches A, B, and D information about paths 1, 2, and 3. Switch C may provide information about the paths via an inform protocol (e.g., the broadcast inform protocol). The information provided may include, for example, a path identifier (e.g., “path 1”), the type of packets which utilize this path (e.g., broadcast, multicast, and unknown destination address packets), an originating switch identifier (e.g., “switch C”), an originating switch MAC address (e.g., 12:34:56:78:ab:cd), an incoming port identifier for the path (e.g., switch A, port 2), and/or an outgoing port identifier (switch A, port 3). It should be noted that there may be multiple outgoing ports in some instances. For example, with respect to path 3, the information provided to switch B may include a path identifier (e.g., “path 3”), the type of packets which utilize this path (e.g., broadcast multicast, and unknown destination address packets), an originating switch identifier (e.g., “switch C”), an originating switch MAC address (e.g., 12:34:56:78:ab:cd), an incoming port identifier for the path (e.g., switch B, port 11), and/or outgoing port identifiers (e.g., switch B, ports 4 and 5). Upon receiving such information, each switch may update internal forwarding tables 150 with this path information. For example, and with reference to FIG. 1, switch A may receive information about path 1 from switch C, and update an internal forwarding table 150 to indicate that broadcast, multicast, and unknown destination address packets assigned to path 1 from switch C should be output via port 3. Similarly, switch A may receive information about path 2 from switch C, and update an internal forwarding table 150 to indicate that broadcast, multicast, and unknown destination address packets assigned to path 2 should be output via port 10. Still further, switch A may receive information about path 3 from switch C, and update an internal forwarding table 160 to indicate that broadcast, multicast, and unknown destination address packets assigned to path 3 should not be output.

Prior or subsequent to the switch distributing information about the paths to the other switches 110 in the meshed switch domain, the switch may (iii) assign attached clients to the plurality of redundant, non-looping paths and inform the other switches about the assignments. For example, each client attached to switch C may be assigned to one of the plurality of redundant, non-looping paths built by switch C. Referring to FIG. 1, therefore, switch C may assign client X to path 2 and assign client Y to path 1. As a result, all broadcast, multicast, and/or unknown destination address packets originating from client X may be sent to the other switches in the meshed switch domain via path 2, and all broadcast, multicast, and/or unknown destination address packets originating from client Y may be sent to the other switches in the meshed switch domain via path 1. Switch C may distribute information about these assignments via an inform protocol (e.g., the MAC inform protocol). The information provided in the inform messaging may comprise, for example, a client identifier (e.g., “client X”), a client MAC address (e.g., 12:34:56:78:cd:00), an assigned path (e.g., path 2), and/or the type of packet to distribute via the assigned paths (e.g., broadcast, multicast, and unknown destination address packets). Upon receiving this information, each switch may update internal forwarding tables 150 with this assignment information. For example, and referring to FIG. 1, switch A may receive information from switch C indicating that client Y is assigned to path 1 and client X is assigned to path 2. Switch C may then update its internal forwarding table 150 to indicate that broadcast, multicast, and unknown destination address packets originating from switch C for client Y are assigned to path 1. Similarly, switch A may update its internal forwarding table 150 to indicate that broadcast, multicast, and unknown destination address packets originating from switch C for client X are assigned to path 2.

Thereafter, the switches 110 (iv) utilize the built paths to transmit incoming broadcast, multicast, and/or unknown destination address packets from the clients 130 to other switches 110 according to their respective path assignments. For example, a broadcast packet sent from client Y to switch C will be forwarded on path 1 such that it is output from port 1 on switch C to port 2 on switch A, and from port 8 on switch C to port 7 on switch D. Switch A will receive the broadcast packet and, based on the information in its internal forwarding table 150, output the broadcast packet from port 3 on switch A to port 4 on switch B. As a result, the broadcast packet received from client Y will be distributed to each of switches A, B, and D via assigned path 1. More specifically, the broadcast packet from client Y will be distributed to each of switches A, B, and D without traversing the same link more than once and without being received by the same switch more than once (i.e., path 1 is a non-looping path in the meshed switch domain).

The above-discussed approach illustrated in FIG. 1 enhances load balancing because broadcast, multicast, and/or unknown destination address packets from various clients are distributed among a plurality of redundant, non-looping paths. Thus, if multiple clients are all sending broadcast packets simultaneously, a bottleneck is not created because the packets are distributed among a plurality of paths (i.e., unlike conventional approaches that distribute the packets via a single path). Furthermore, in the event of a segment failure, latency is mitigated because the switch can promptly assign traffic from a client to another path (i.e., unlike conventional approaches that wait for the segment to be rebuilt). For instance, a mesh switch may determine that a segment associated with one of the paths has failed in response to, e.g., receiving a segment/path failure indication or not receiving an acknowledgment packet. The mesh switch may then proceed to rapidly determine which clients are currently assigned to that the path associated with the failed segment, and determine an alternative path for each client. The switch may then proceed to distribute information about the new client path assignments to the other switches in the meshed switch domain, and re-forward packets if necessary. Thereafter, in response to the mesh switch receiving or otherwise determining that the segment/path has been rebuilt, the switch may re-assign the clients back to their original path.

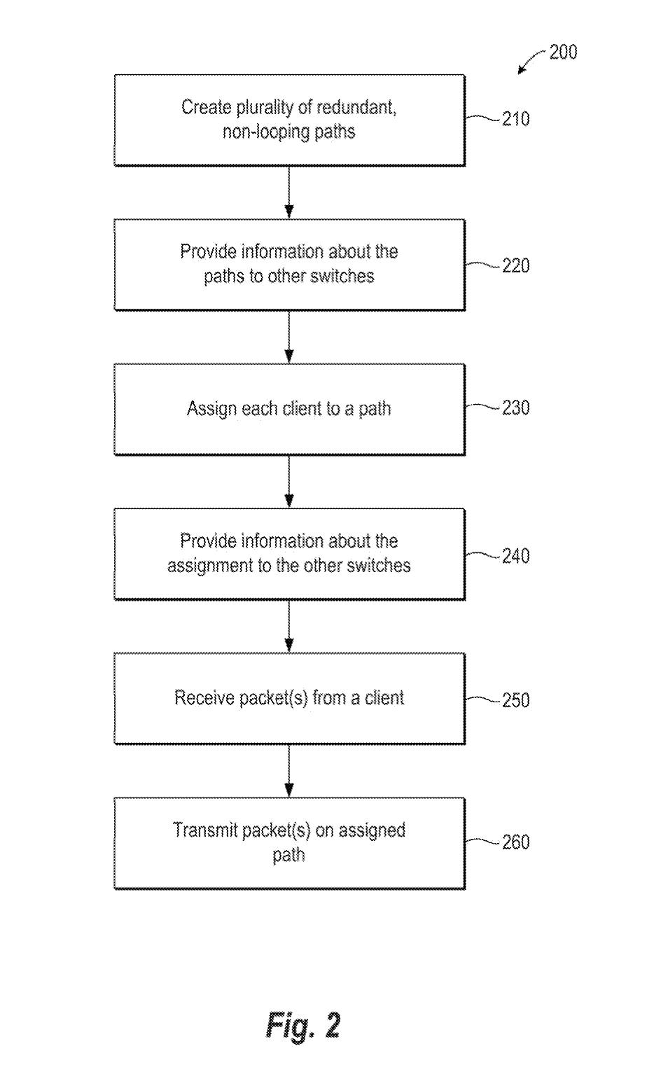

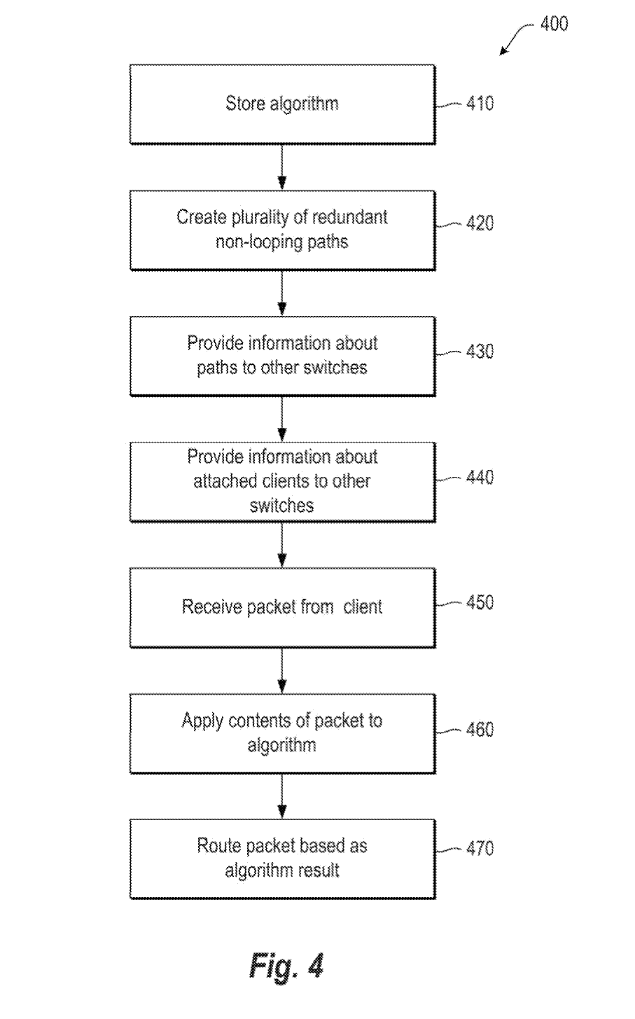

FIG. 2 depicts a process flow diagram 200 in accordance with an embodiment. It should be readily apparent that the processes depicted in FIG. 2 (as well as FIG. 4) represent generalized illustrations, and that other processes may be added or existing processes may be removed, modified, or rearranged without departing from the scope and spirit of the present disclosure. Further, it should be understood that the processes may represent executable instructions that cause a computer, processor, and or logic device associated with a switch 110 to respond, to perform actions, to change states, and/or to make decisions. Thus, the described processes may be implemented as processor executable instructions and/or operations provided by a computer-readable medium associated with a switch 110. Moreover, processes may represent functions and/or actions performed by functionally equivalent circuits like an analog circuit, a digital signal processor circuit, an application specific integrated circuit (ASIC), or other logic devices associated with a switch 110. FIG. 2 is not intended to limit the implementation of the described embodiments, but rather the figures illustrate functional information one skilled in the art could use to design/fabricate circuits, generate software, or use a combination of hardware and software to perform the illustrated processes.

The process begins at block 210, when a mesh switch creates a plurality of redundant, non-looping paths to the other switches in the meshed switch domain. This process may comprise the switch utilizing a discovery protocol to identify the various switches, ports, and/or segments in the meshed switch domain, and the switch creating a plurality of redundant, non-looping paths based at least in part on this detected information. The switch may store the information about the created paths in an internal memory comprising a forwarding table. Moreover, at block 220, the switch may provide information about the created paths to the other switches in the domain. This may comprise the switch notifying each switch about paths relevant to the respective switch, or, alternatively, notifying all switches about all paths so that each may be aware of the entire forwarding scheme. As discussed above, such information may be distributed via an inform protocol (e.g., the broadcast inform protocol), which provides path information such as a path identifier (e.g., “path 1”), the type of packets which utilize this path (e.g., broadcast, multicast, and unknown destination address packets), an originating switch identifier (e.g., “switch C”), an originating switch MAC address (e.g., 12:34:56:78:ab:cd), an incoming port identifier for the path (e.g., switch A, port 2), and/or outgoing port identifier(s) (e.g., switch A, port 3) to the other switches.

At block 230, the switch assigns clients to paths. More precisely, the switch assigns all attached clients to one of the plurality of paths built in block 210. This process may be conducted initially when the switch joins the meshed switch domain based on clients attached to the switch at that time, as well as in the future when clients attach to the switch. The switch may store information about the client assignments in an internal forwarding table and, at block 240, the switch may provide information about the client assignment to the other switches in the meshed switch domain. The switch may provide the information via an inform protocol, and the information may comprise, for example, a client identifier (e.g., “client X”), a client MAC address (e.g., 12:34:56:78:cd:00), an assigned path (e.g., path 2), and/or the type of packet to distribute via the assigned paths (e.g., broadcast, multicast, and unknown destination address packets). Upon receiving this assignment information, each switch may update internal forwarding tables so that each switch may know how to handle packets associated with each client.

At block 250, the switch may receive a packet from the client. If the packet is a broadcast, multicast, or unknown destination address packet, the switch may refer to its internal forwarding table and, at block 260, transmit the packets based on the path previously assigned to the client in block 230. The other switches may receive the broadcast, multicast, or unknown destination address packets and, similariy, refer to their internal forwarding table and forward if necessary.

Although not depicted in FIG. 2, the process may further comprise the switch receiving or otherwise determining that a segment associated with one of the paths has failed. In response to this event, the switch may proceed to determine which clients are assigned to that the path associated with the failed segment, and determine alternative paths for each client. The switch may then proceed to provide information about the new client path assignments to the other switches in the meshed switch domain. Thereafter, in response to the switch receiving or otherwise determining that the segment has been repaired, the switch may re-assign the clients back to their original path.

It should be noted that the above-described processes described with respect to FIG. 2 may be conducted by each switch in the meshed switch domain. For example, one or more of the processes described above may be conducted by one or more of switches A-D as described with respect to FIG. 1.

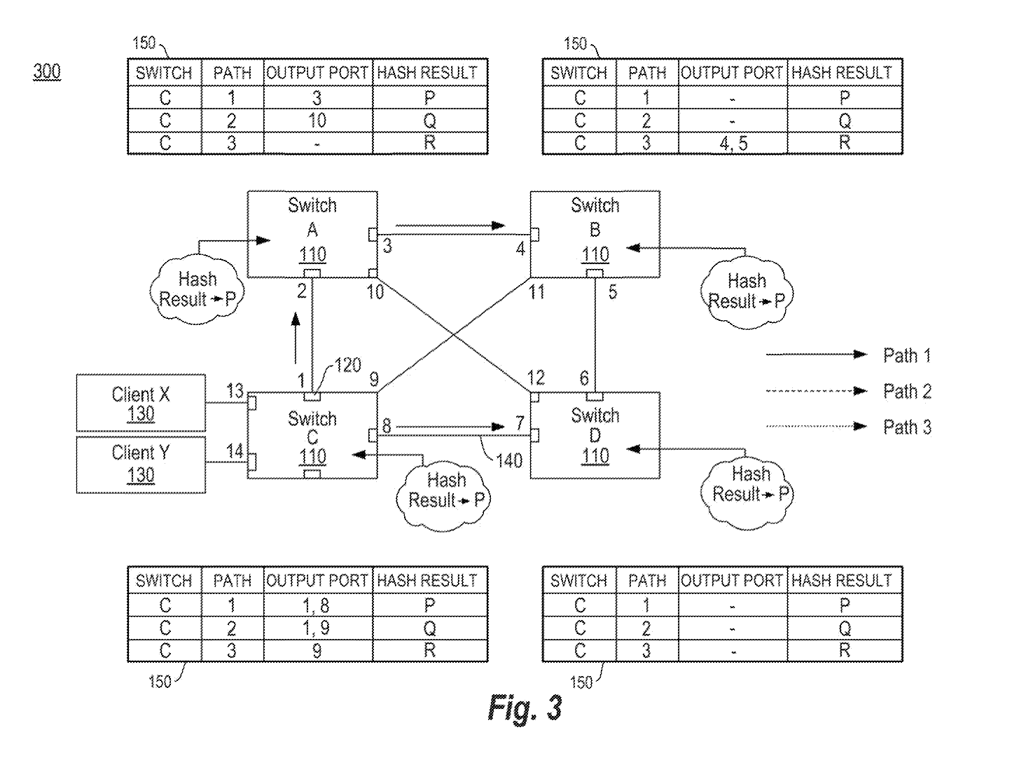

FIG. 3 depicts a system 300 in accordance with another embodiment, it should be understood that the system 300 depicted in FIG. 3 represents a generalized illustration and that other elements may be added or existing elements may be removed, modified, or rearranged without departing from a scope of the present disclosure.

Similar to the system 100 depicted in FIG. 1, the system 300 in FIG. 3 comprises a plurality of switches 110 (each with a plurality of ports 120), a plurality of clients 130, and a plurality of segments 140. The switches 110, ports 120, clients 130, and segments operate in largely the same manner as described above with regard to FIG. 1. However, one area of differentiation is that incoming broadcast, multicast, or unknown destination address packets are dynamically assigned to paths as opposed to being pre-assigned based on client assignments as discussed with respect to FIG. 1. More specifically, information associated with incoming broadcast, multicast, and unknown destination address packets are input into an algorithm (e.g., a hash algorithm), and the result is used to determine which path to assign the packet to. The information associated with the incoming broadcast, multicast, and unknown destination address packets may comprise a physical ingress port on which traffic arrives, a source media access control (MAC) address, a destination MAC address, a source Internet protocol (IP) address, a destination IP address, an IP protocol field, a transmission control protocol (TCP) source port, a user datagram protocol (UDP) source port, a TCP destination port, a UDP destination port, a priority, a differentiated services code point (DSCP), and an EtherType.

For example, referring to FIG. 3, switches A, B, C, and D may agree on and store a hash algorithm to apply to all incoming broadcast, multicast, and unknown destination address packets. When client Y sends a broadcast, multicast, or unknown destination address packet to switch C, switch C may take the contents of the packet and apply them to the hash algorithm. For instance, switch C may take an XOR of the packet's source/destination MAC addresses, EtherType, IP protocol, and source/destination IP addresses. The hash result may be “P” which may be mapped/indexed to path 1. Therefore, based on the contents in switch C's forwarding table 150, switch C may forward the packet from port 1 on switch C to port 2 on switch A, and from port 8 on switch C to port 7 on switch D. Switches A and D may receive the packet and similarly take the contents within the packet and apply the contents to the hash algorithm. Because the hash algorithm in each switch is the same, switches A and will obtain the same hash result as switch C (i.e., hash result=“P”), and therefore determine that path 1 should be utilized for this packet. Based on its forwarding table 150, switch A will then forward the packet from port 3 on switch A to port 4 on switch B. Switches B and D, by contrast, will refrain from forwarding the packet because their respective forwarding tables 150 indicate that no forwarding should be conducted for packets assigned to path 1.

It should be noted that the above-mentioned forwarding in FIG. 3 may be flow-based, where all packets belonging to the same traffic flow or packet flow may be assigned to the same path. That is, a sequence of packets from a client belonging to the same flow will be assigned to the same path within the meshed switch domain. This may be accomplished by applying the first packet in the flow to a stored algorithm and determining an appropriate path. Thereafter, all packets in the same flow will be assigned to the same path. By contrast, if a switch receives packets belonging to two different flows from a client, there is a statistical chance that the processing of information associated with a packet of each flow will result in different hash results, and therefore the flows may be assigned to different paths in the meshed switch domain. This may be beneficial because the distribution of the flows among the paths may provide better load balancing and eliminate any potential bottleneck that may have been created if the flows were assigned to the same path.

FIG. 4 depicts a process flow diagram 400 in accordance with an embodiment. It should be readily apparent that the processes depicted in FIG. 4 represent generalized illustrations, and that other processes may be added or existing processes may be removed, modified, or rearranged without departing from the scope and spirit of the present disclosure.

The process begins at block 410, where a switch stores an algorithm to apply to incoming broadcast, multicast, and unknown destination address packets. In particular, each switch in the meshed switch domain stores the same algorithm. These algorithms may be determined by a negotiation process between the various switches in the domain, where a common algorithm that each switch can support is selected. Alternatively, the algorithm may be selected by a single switch and the other switches may be instructed to store and utilize the algorithm. Still further, the algorithm may be determined by a control device and each switch may be instructed to store and utilize the algorithm. As mentioned above, the algorithm may be, for example, a hash function that directly or indirectly maps contents from an incoming broadcast, multicast, and unknown destination address packet to one of a plurality of paths. For example, the hash function may map the packet's source/destination MAC addresses, EtherType, IP protocol, and/or source/destination IP addresses directly or indirectly to one of a plurality of paths.

At block 420, the switch may build a plurality of redundant, non-looping paths to the other switches in the meshed switch domain. This process may comprise the switch utilizing a discovery protocol to identify the various switches, ports, and/or segments in the domain, and creating a plurality of redundant, non-looping paths based at least in part on this detected information. The switch may store information about the created paths in an internal memory comprising a forwarding table. Then, at block 430, the switch may provide information about the created paths to the other switches in the domain. This may comprise the switch notifying each switch about paths relevant to the respective switch, or, alternatively, notifying all switches about all paths so that each may be aware of the entire forwarding scheme. As discussed above, such information may be distributed via an inform protocol (e.g., the broadcast inform protocol), which may provide path information such as a path identifier (e.g., “path 1”), the type of packets which utilize this path (e.g., broadcast, multicast, and unknown destination address packets), an originating switch identifier (e.g., “switch C”), an originating switch MAC address (e.g., 12:34:56:78:ab:cd), an incoming port identifier for the path (e.g., switch A, port 2), and/or an outgoing port identifier (switch A, port 3) to the other switches.

At block 440, the switch may provide information about its attached clients to the other switches in the meshed switch domain. For example, a switch may utilize a MAC inform protocol to inform other switches that various clients are located on the switch. In addition, the switch may inform the other switches that broadcast, multicast, and unknown destination address packets with these clients as the source MAC should be forwarded on one of the switch's paths provided at block 430.

Thereafter, at block 450, the switch may receive a packet from an attached client and, at block 460, apply contents of the packet to the saved algorithm. Then, based at least in part on the algorithm result, the switch forwards the packet on one of the plurality of redundant, non-looping paths. In addition, the switch forwards subsequent packets belonging to the same flow on the same path.

The above-mentioned approach enhances load balancing because broadcast, multicast, and/or unknown destination address packets are forwarded dynamically on a flow-by-flow basis. Therefore, if one client is sending a large number of broadcast packets belonging to different flows, the packets may be dynamically distributed among the various paths through the mesh. Moreover, the above-mentioned approach enhances reliability because, if a segment in a broadcast path were to fail, the traffic assigned to that path could be reassigned to one of the other paths, thus reducing dropped traffic and/or latency, as discussed above.

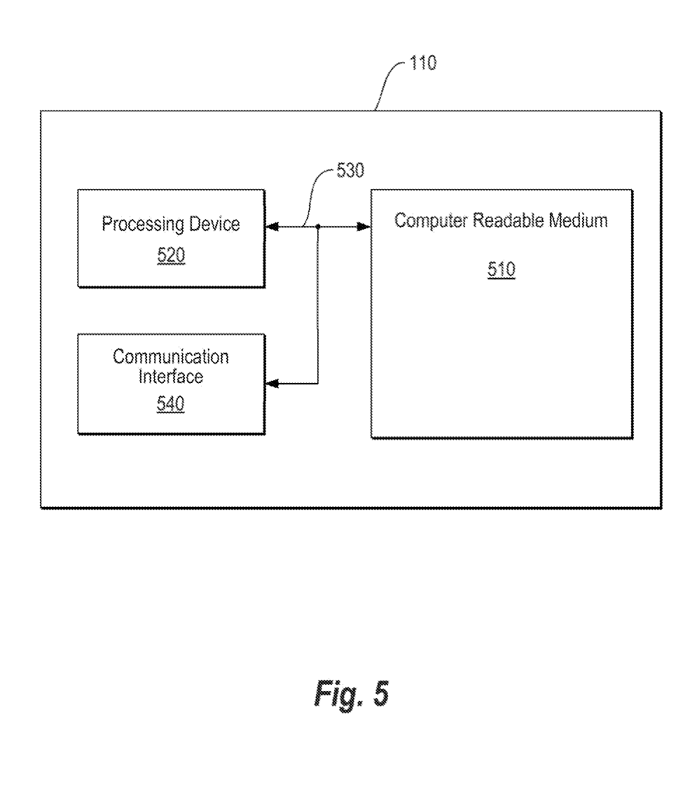

Turning now to FIG. 5, there is shown a block diagram of a mesh switch 110, which may be employed to perform one or more of the above-described functions, in accordance with an embodiment. The mesh switch 110 includes a non-transitory computer-readable medium 510, a processing device 520, a bus 530, and a communication interface 540.

The non-transitory computer-readable medium 510 may be a device that stores machine readable instructions. For example, the non-transitory computer-readable medium 510 may correspond to any typical storage device that stores instructions, codes, data, and/or other information, and may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical devices, and flash memory devices.

The processing device 520 may be a device that generally retrieves and executes the instructions stored in the non-transitory computer-readable medium 510. For example, the processing device may be a central processing unit (CPU), processor, microcontroller, or the like. In some embodiments, the processing device 520 may access the non-transitory computer-readable medium 510 over a bus 530. In other embodiments, the non-transitory computer-readable medium 510 may be integrated with the processing device 520.

The communication interface 540 may be a one or more components within the switch 110 that enable the switch 110 to communicate with other devices (e.g., clients and/or other switches). For example, the communication interface 540 may comprise ports, receivers, transmitters, transceivers, PHYs, and the like.

The computer-readable medium 510, processing device 520, and/or communication interface 540 may collaborate with each other and/or with other components (e.g., an application-specific integrated circuit (ASIC)) to conduct various functions described above with respect to FIGS. 1-4. For example, the components may collaborate to (i) build a plurality of redundant, non-looping paths to the other switches in the meshed switch domain, (ii) distribute information about the built paths to the other switches in the meshed switch domain, (iii) assign clients to the built paths and inform the other switches in the meshed switch domain of the assignments, and/or (iv) utilize the built paths to transmit incoming broadcast, multicast, and/or unknown destination address packets from the clients to other switches in the meshed switch domain. Furthermore, the components may collaborate to (i) store an algorithm to apply to incoming packets, (ii) create a plurality of redundant, non-looping paths to a plurality of switches, (ill) provide information to the plurality of switches about the plurality of redundant, non-looping paths, (iv) provide information to the plurality of switches about a plurality of attached clients, (v) receive a packet from one of the plurality of attached clients, (vi) apply information associated with the packet to the algorithm to produce a forwarding result, (vii) select one of the plurality of redundant, non-looping paths based at least in part on the forwarding result, and/or (viii) transmit the packet on the selected one of the plurality of redundant non-looping paths.

The present disclosure has been shown and described with reference to the foregoing exemplary embodiments. It is to be understood, however, that other forms, details, and embodiments may be made without departing from the spirit and scope of the disclosure that is defined in the following claims.

What is claimed is:

1. A method comprising:
creating a plurality of redundant non-looping paths to a plurality of switches;
providing information to the plurality of switches about the plurality of redundant, non-looping paths;
assigning each of a plurality of clients to one of the plurality of redundant, non-looping paths;
providing information to the plurality of switches about which of the plurality of redundant, non-looping paths each client of the plurality of clients is assigned to;
receiving a packet from a client of the plurality of clients; and
transmitting the packet on one of the plurality of redundant, non-looping paths to at least one of the plurality of switches based at least in part on which of the plurality of redundant, non-looping paths the client is assigned to.

2. The method of claim 1, wherein the packet is a broadcast packet, a multicast packet, or an unknown destination address packet.

3. The method of claim 1, wherein each of the plurality of switches store information about the plurality of redundant, non-looping paths, and further store information about which of the plurality of redundant, non-looping paths each client of the plurality of clients is assigned to.

4. The method of claim 1, wherein the plurality of switches are mesh switches operating in a meshed switch domain.

5. The method of claim 1, further comprising providing different information to the plurality of switches about which of the plurality of redundant, non-looping paths a client of the plurality of clients is assigned to in response to determining that at least one of the redundant, non-looping paths failed.

6. A method comprising:
storing an algorithm to apply to incoming packets;
creating a plurality of redundant, non-looping paths to a plurality of switches;
providing information to the plurality of switches about the plurality of redundant, non-looping paths;
providing information to the plurality of switches about a plurality of attached clients;
receiving packet from one of the plurality of attached clients;
applying information associated with the packet to the algorithm to produce a forwarding result;
selecting one of the plurality of redundant, non-looping paths based at least in part on the forwarding result; and
transmitting the packet on oh the selected one of the plurality of redundant non-looping paths.

7. The method of claim 6, wherein the algorithm is a hash algorithm.

8. The method of claim 6, wherein the information associated with the packet comprises at least one of a physical ingress port on which traffic arrives, a source media, access control (MAC) address, a destination MAC address, a source Internet protocol (IP) address, a destination IP address, an IP protocol field, a transmission control protocol (TCP) source port, a user datagram protocol (UDP) source port, a TCP destination port, a UDP destination port, a priority, a differentiated services code point (DSCP), and an EtherType.

9. The method of claim 6, wherein the packet is a broadcast packet, a multicast packet, or an unknown destination address packet.

10. The method of claim 6, further comprising:
receiving a second packet; and
transmitting the second packet on the selected one of the plurality of redundant non-looping paths if the second packet belongs to the same traffic flow as the packet.

11. The method of claim 6, further comprising:
receiving the packet at one of the plurality of switches;
applying information associated with the packet to the algorithm to produce a second forwarding result;
selecting one of the plurality of redundant, non-looping paths based at least in part on the second forwarding result; and
transmitting the packet on the selected one of the plurality of redundant non-looping paths.

12. A system comprising:
a first switch to
store an algorithm to apply to incoming packets,
provide information to a second switch about a plurality of redundant, non-looping paths and attached clients,
apply information associated with a received packet to the algorithm to produce a forwarding result,
select one of the plurality of redundant, non-looping paths based at least in part on the forwarding result, and
transmit the packet on the selected one of the plurality of redundant, non-looping paths; and
the second switch to
store the algorithm to apply to incoming packets,
store the information about the plurality of redundant, non-looping paths and the attached clients,
receive the packet originating at the first switch, and
apply information associated with the received packet to the algorithm to produce a second forwarding result.

13. The system of claim 12, wherein the first switch and the second switch are mesh switches operating in a meshed switch domain.

14. The system of claim 12, wherein the first forwarding result and the second forwarding result are mapped to the plurality of redundant, non-looping paths.

15. The system of claim 12, wherein the algorithm is a hash algorithm.
